(19) United States
(12) Patent Application Publication
(10) Pub. No.: US 2024/0009935 A1
(43) Pub. Date: Jan. 11, 2024

(54) FRACTURABLE SUPPORT STRUCTURE AND METHOD OF FORMING THE STRUCTURE

(71) Applicant: XEROX CORPORATION, NORWALK, CT (US)

(72) Inventors: Gabriel Iftime, Cupertino, CA (US); Daniel Bullard, Palo Alto, CA (US); Junhua Wei, Palo Alto, CA (US)

(73) Assignee: XEROX CORPORATION, NORWALK, CT (US)

(21) Appl. No.: 17/859,804

(22) Filed: Jul. 7, 2022

(51) Int. Cl. B29C 64/40; B29C 64/165; B22F 10/43; B22F 10/47

(52) U.S. Cl. CPC B29C 64/40; B29C 64/165; B22F 10/43; B22F 10/47; B33Y 10/00

(57) ABSTRACT

An embodiment of the present disclosure is directed to a method of additive manufacturing. The method comprises: i) forming a first layer, the first layer comprising at least one material chosen from an article material, a support structure material and a fracturable material; ii) forming an additional layer on the first layer, the additional layer comprising at least one material chosen from the article material, the support structure material and the fracturable material; and iii) repeating ii) one or more times to form a three-dimensional build comprising an article and at least one support structure attached to the article at an interface, the interface comprising the fracturable material formed during one or more of i), ii) or iii), the fracturable material comprising a salt. A three-dimensional build is also disclosed.

### DETAILED DESCRIPTION

### Field of the Disclosure

The present disclosure is directed to a three-dimensional build that includes a support structure attached to an article at a fracturable interface, and a method of additive manufacturing for making the three-dimensional build.

### Background

Because additive manufacturing is carried out one layer at a time, support structures are often employed to support the structure during the printing process. These support structures can take the form of, for example, a plurality of pillars that support an overhang structure of a part being printed. The support structures serve multiple functions. For example, they provide structural stability to the layers deposited as an article being printed (sometimes referred to as a “part”) widens out from a narrower base region. The support provided by these structures allows more complex geometries to be printed and can allow for reduced weight of the final part. Additionally, support structures allow for improved thermal management during printing, especially when printing metals. These structures provide a path for thermal energy to move from the part to heat sinks, or from heat sources into the part. Support structures can be developed using the same material being used to make the part, or if the printer has the capability to print multiple materials, can be printed from a second material.

One problem with many support structures, especially with metal printing, is they are not easily removed from the part. A significant amount of time and/or money can be spent during “post processing” to fully remove the support structures and smooth or polish the remaining rough areas left on the part surface. Further, such support structures can result in degraded quality of the final printed part surface.

Improved support structures and methods of additive manufacturing that employ the support structures would be a desirable step forward in the art.

### SUMMARY

An embodiment of the present disclosure is directed to a method of additive manufacturing. The method comprises: i) forming a first layer, the first layer comprising at least one material chosen from an article material, a support structure material and a fracturable material; ii) forming an additional layer on the first layer, the additional layer comprising at least one material chosen from the article material, the support structure material and the fracturable material; and iii) repeating ii) one or more times to form a three-dimensional build comprising an article and at least one support structure attached to the article at an interface, the interface comprising the fracturable material formed during one or more of i), ii) or iii), the fracturable material comprising a salt.

Another embodiment of the present disclosure is directed to a method of additive manufacturing. The method comprises: i) jetting droplets comprising a first print material to form a first layer, the first layer comprising at least one material chosen from an article material, a support structure material and a fracturable material; ii) jetting additional droplets comprising the first print material to form an additional layer on the first layer, the additional layer comprising at least one material chosen from the article material, the support structure material and the fracturable material; and iii) repeating ii) one or more times to form a three-dimensional build comprising an article and at least one support structure attached to the article at an interface, the interface comprising the fracturable material formed during one or more of i), ii) or iii), the fracturable material being formed by exposing portions of the first print material in at least one form chosen from the droplets, the additional droplets, the first layer and the addition layer with a reactant.

Yet another embodiment of the present disclosure is directed to a three-dimensional build. The three-dimensional build comprises an article comprising a first print material. At least one support structure is attached to the article at a fracturable interface. The fracturable interface comprises a second print material that is different from the first print material.

It is to be understood that both the foregoing general description and the following detailed description are exemplary and explanatory only and are not restrictive of the present teachings, as claimed.

### BRIEF DESCRIPTION OF THE DRAWINGS

The accompanying drawings, which are incorporated in and constitute a part of this specification, illustrate embodiments of the present teachings and together with the description, serve to explain the principles of the present teachings.

FIG. 1 is a flow chart of a method of additive manufacturing, according to an embodiment of the present disclosure.

FIG. 2A illustrates a schematic side view of a first layer deposited on a build plate of a 3D printer, according to an embodiment of the present disclosure.

FIG. 2B illustrates an example of a partially finished three-dimensional build after a plurality of layers have been formed, according to an embodiment of the present disclosure.

FIG. 2C illustrates an example of a completed three-dimensional build prior to post processing comprising an article and at least one support structure attached to the article at an interface, according to an embodiment of the present disclosure.

FIG. 3A is a schematic cross-sectional view of a single liquid ejector jet configured for jetting modified compositions, according to an embodiment of the present disclosure.

FIG. 3B is a schematic cross-sectional view of a single liquid ejector jet configured for jetting various material compositions, according to an embodiment of the present disclosure.

It should be noted that some details of the figure have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. In the drawings, like reference numerals have been used throughout to designate identical elements. In the following description, reference is made to the accompanying drawings that forms a part thereof, and in which is shown by way of illustration a specific exemplary embodiments in which the present teachings may be practiced. The following description is, therefore, merely exemplary.

The present disclosure is directed to a method of making a three-dimensional build and the build products formed thereby. The three-dimensional build comprises an article comprising a print material. At least one support structure is attached to the article at a fracturable interface. The fracturable interface comprises a polymer that is the same or different from the print material. A small amount of the polymer at the interface between the support structure and the 3D article can weaken the interface while still allowing for the desired support of the 3D article and/or the desired conduction of thermal energy away from the 3D article to, for example, heat sinks. The areas of no or weak bonding at the interface will create a fracture, or cleavage, zone that will allow the support structures to be easily removed after printing. Examples of the present disclosure include printing a salt-based printing material or a polymer-based printing material as a support structure for a 3D printed article. Examples of the present disclosure aldo include printing a metal-based printing material as a support structure having a cleavage layer or fracturable interface in between a support structure and a 3D printed article. In certain examples, the fracturable interface or cleavage layer may include any of the materials as described herein for use within a fracturable interface.

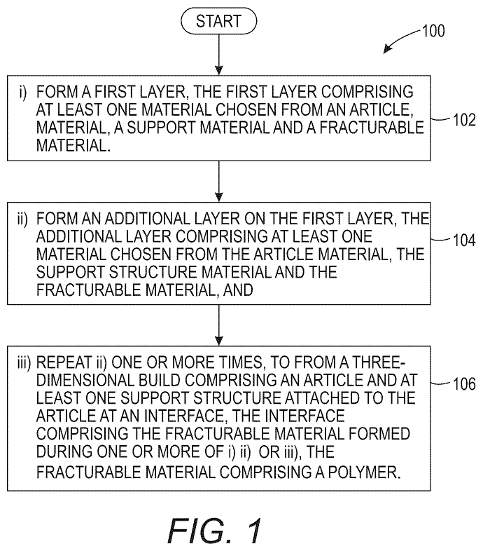

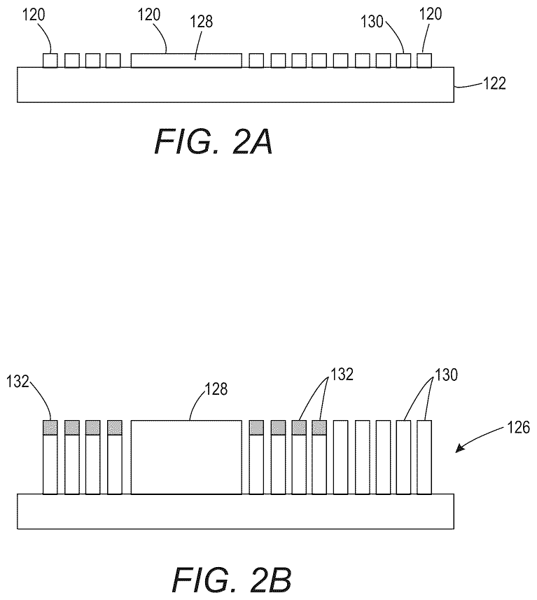

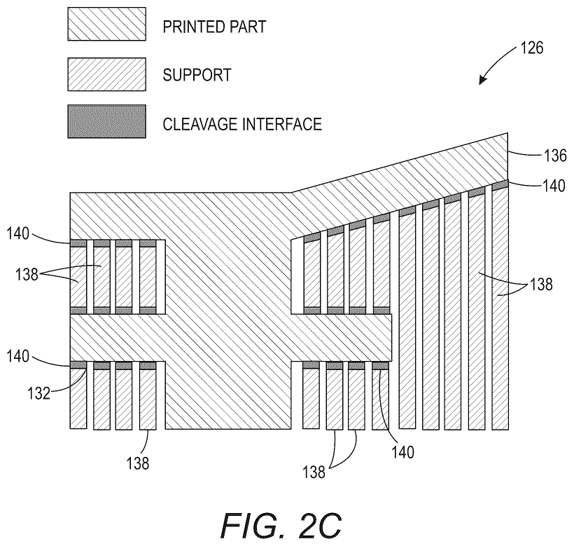

FIG. 1 is a flow chart of a method of additive manufacturing 100, according to an embodiment of the present disclosure. As shown at 102 of FIG. 1, the method comprising forming a first layer. The first layer comprises at least one material chosen from an article material, a support structure material and a fracturable material. FIG. 2A illustrates a schematic side view of an example of a first layer 120 deposited on a build plate 122 of a 3D printer (not shown). The term “on” as employed herein is defined broadly so as not to require direct physical contact and encompasses configurations of both direct physical contact and indirect physical contact. Thus, intervening layers can be positioned between the first layer and the build plate, or the first layer can be directly on the build plate, for example. Unless otherwise made clear by the disclosure, each occurrence of the term “on” herein provides support for the concept of direct physical contact.

As shown at 104 of FIG. 1, an additional layer is formed on the first layer. The additional layer can also comprise at least one material chosen from the article material, the support structure material and the fracturable material. The process of forming layers, as shown at 104, is repeated one or more times to form a three-dimensional build, as shown at 106.

Any of the layers deposited to form the three-dimensional build can comprise one or more types of material. For example, the three-dimensional build can be comprised of a first print material, a second print material, or a third print material. Each of the first print material, second print material, or third print material may be used to fabricate or additively manufacture any of the layers or portions of the three-dimensional build according to the present disclosure. FIG. 2B illustrates an example of a partially finished three-dimensional build 126 after a plurality of layers have been formed. The topmost portion of the partially finished three-dimensional build 126 is shown comprising article material 128, support structure material 130 and fracturable material 132. The layer in FIG. 2A, on the other hand, is only shown to comprise article material 128 and support structure material 130. Further, a single layer can comprise only article material, only support material, only fracturable material, or any combination of these materials. The article material can be the same or different than the support material. Advantages of both the article material and the support material being the same print material include a potential for improved thermal conduction characteristics of the structural supports because the article and supports have similar thermal conductivity and the ability to print the entire structure with fewer (e.g., a single) print nozzle.

The finished three-dimensional build comprises an article and at least one support structure attached to the article at an interface. The interface can comprise the fracturable material that was formed during one or more of the layer forming processes of method 100. As will be described in greater detail below, the fracturable material is formed from a printable polymer material or by exposing a polymer-based print material, such as, for example, the support structure material, with a reactant. Suitable reactants will be described in further detail. FIG. 2C illustrates an example of a finished three-dimensional build 126 comprising an article 136 and at least one support structure 138 attached to the article at an interface 140.

The article 136 can comprise any suitable material that can be deposited by additive manufacturing. In an embodiment, the article material is a metal, such as aluminum, aluminum alloys (e.g., alloys 4008 and 6061 or any others), cupper, copper alloys, silver, silver alloys, iron or iron alloys, such as steel, or other metals. In certain examples, the article 136 can comprise a filament-based printable material, a polymer, a salt or mineral-based material, or a combination thereof. In other examples, printable materials may include ceramics, polymer composites, or combinations with other materials described herein.

The at least one support structure 138 can comprise any suitable material that can be deposited by additive manufacturing and that can provide the desired support. In an embodiment, the support structure material is a metal, such as aluminum, aluminum alloys (e.g., alloys 4008 and 6061 or any others), copper, copper alloys, silver, silver alloys, iron or iron alloys, such as steel, or other metals. The at least one support structure 138 can comprise a filament-based printable material, a polymer, a salt or mineral-based material, or a combination thereof in alternate examples. The width and spacing of the support structures 138 can vary with both the material being printed and the geometry of the article 136. Examples of width dimensions for support structures 138 include diameters of about 0.5 mm to about 5 mm, such as about 1 mm to about 2 mm for a cylindrical pillar type structure. For support structures with non-circular cross-sections, these same width dimensions can be applied to the shortest width dimension that intersects the longitudinal axis of the support structure. Examples of spacing between the support structures 138 include distances of about 2 mm to about 20 mm, such as about 4 mm to about 8 mm. The longer the overhang (e.g., such as the overhangs shown in FIG. 2C), the closer the spacing can be between the support structures 138, in order to provide the desired support. In an example, a ratio of the total length of an overhang to the total width (e.g., diameter) of all of the support structures providing support to the overhang ranges from about 10:1 to about 2:1.

The at least one interface 140 can comprise any suitable fracturable material that: can be formed from a polymer-based, ceramic-based, glass-based, or salt-based material, or by reacting a gas or other reactant with the print material that is used to form the support structure; and can provide the desired support while being readily fracturable. The fracturable material can have one or more, or all, of the following properties: a limited reactivity with the first material or second material being printed; be printable; be thermally stable at build temperatures; a sufficient thermal conductivity so as not to excessively interfere with local microstructure development; and the ability to allow the desired metal or other print material to be deposited thereon (e.g., it is wettable by the printed metal). In certain examples, the fracturable material can have one or more of the following properties: solubility in a liquid or solvent, such as water or alcohol; a melting point at or above a printing temperature of another printing material used in the three-dimensional build; a glass transition temperature at or above a printing temperature of another printing material used in the three-dimensional build; and a decomposition temperature above a printing temperature of another printing material used in the three-dimensional build.

The fracturable material can be a modified polymer or salt. The term “modified” as used herein means that at least a portion of the print material is formed by reacting a gas with a print material in solid or liquid form to form the modified fracturable material. In an embodiment, the fracturable material is formed by exposure of the print material to a gaseous or liquid reactant such that the print material is modified in a manner that renders the print material readily fracturable.

Examples of reactants or reactant gases that can be employed to convert the print material to a fracturable material during the additive manufacturing process include oxygen-containing gases, such as oxygen gas (O₂), oxygen plasma, ozone (O₃) and water gas (H₂O); nitrogen-containing gases, such as ammonia (NH₃) or nitrogen gas (N₂); solvent vapor; polymers or monomers having a low molecular weight suitable for diffusion within a printable polymer material; or water vapor.

In certain examples, a printed material may form any of the article, support structure, or fracturable material or fracturable interface and can comprise a metal, salt, polymer, or combination thereof in accordance with the present disclosure. In one example, printing a high char yield polymer or resin onto the interface between a supportive structure and structural metal may form an interlayer or fracturable interface by curing and decomposing a printed polymer resin into carbon, silicon carbide (SiC), or other ceramic at elevated temperatures, followed by breaking the interface after printing. In certain examples, polymers may be used to create a fracturable interface, and in certain examples can require a second printer, second ejector, or second deposition apparatus. Printed polymer parts, support structures, or fracturable interfaces may be either fracturable or dissolvable. In certain examples, a formation of a nitride or an oxide can occur when the polymer-based print material is exposed to a reactant. High-temperature stable polymers in the form of a powder, paste, mixture of powders with solvent, and the like may be used in methods according to the present disclosure. A viscosity of the polymer formulation can be tailored to maintain shape instead of or along with cooling, as cooling between metal and polymer printing could be prohibitive in certain examples. Alternatively, the introduction of particles or other disruptive materials into a polymer print material that can provide a shear thinning interface via particle or long-chain polymers may be used. Printing a pyrolyzed polymer precursor under curing temperature and onto a hot substrate to cure and pyrolyze can create a ceramic structure. Additionally, oxides or network formation due to pyrolyzing could occur within a polymer formulation. In certain examples, a polymer can comprise a metal in the precursor, which can further react with a previously printed metal to form a fracturable interface. A high char yield polymer may be defined as a polymer or resin that once subjected to temperatures at or above its decomposition temperature, is pyrolyzed yet still forms a stable material having physical integrity capable of supporting a printed 3D object. Furthermore, two general classifications of high char yield polymers can be used, i.e. monomer-based or polymer-based. The monomer can be cured or crosslinked during a printing operation to form a polymer and thus a stable printed material structure. During a subsequent pyrolyzing step approximately 20 wt % of the cured polymer weight will remain and be converted to a ceramic, such as, for example, graphite, silicone carbide, or any other kinds of ceramic which can be dependent upon the monomer and subsequently formed polymer composition. In the example of a polymer, for example, polyacrilonitrile, can be melted during printing, in which case the expected char yield can be larger than 20 wt %. Illustrative polymers can include benzoxazine, phenolic resin, and the like. Relevant properties of a high char yield polymer include printability of a high char yield resin onto the interface between supportive and structural metals, thermal stability at printing temperatures, low contact angle with aluminum or other metals, and ability to break after the entire part including the 3d printed article, support structure and fracturable interface is cooled to room temperature. Similar processes can be applied to thermally stable polymers as well. Illustrative examples of such a high char yield polymer or thermally stable polymer include polybenzoxazine, polyether ether ketone (PEEK), polybenzimidazole (PBI), polyamide, or combinations thereof. Certain examples of high char yield polymers may be loaded with oxide, nitride, or carbide mineral filler materials such as silicon carbide, silicon dioxide, tungsten carbide, titanium dioxide, titanium (III) oxide, aluminum oxide, or combinations thereof. Such mineral fillers may be incorporated into the high char yield polymers in amounts from 1% wt to about 40% wt, or from about 10% wt to about 30% wt, or from about 15% wt to about 30% wt, based on a weight of the high char yield polymer. In certain examples, the polymer materials may be printed and allowed to cool or may alternatively be subjected to certain temperatures such that the polymer is decomposed to provide a fracturable material. In certain examples, the polymer materials may be printed or subjected to elevated temperature in the presence of argon, nitrogen, oxygen, or other gases.

Print materials comprising a salt can also be used in accordance with methods or materials described in the present disclosure. For example, a reactive or unreactive salt, with respect to a print material the salt can be in contact with, can be printed and subsequently placed in contact with water to dissolve any salt-based interfaces or support structures from a finished part. A formulation comprising a fine powder or micropowder comprising a salt in the form of a liquid or paste dispersion in a solvent can be used. Upon printing, the solvent evaporates either via evaporation in ambient conditions, in exposure to elevated temperatures, or by other means known to those skilled in the art. In certain examples, a salt can be dispersed in a solvent in which it is not soluble, and additives such as thickeners can be incorporated to increase or decrease viscosity as desired. In certain examples, salt-based print materials may be printed in the form of molten salts. In certain examples, a print material comprising a salt can be printed onto a metal, wherein the salt corrodes the interface at the surface of the metal, forming an oxide, chloride, nitride, and the like, which can form a fracturable interface. Illustrative examples can include potassium chloride, sodium chloride, sodium bicarbonate, sodium nitride, and combinations thereof.

While FIG. 2C shows that the fracturable interface 140 are disposed only at one or more terminus of the support structure attached to the article 136, other configurations for the interface 140 that allow for easy removal of the support structures can be employed. For example, any suitable amount of the support structure can comprise the fracturable material. In an embodiment, the entire support structure 138, or substantially the entire support structure 138, comprises a polymer or polymeric fracturable material. In another embodiment, the entire support structure 138, or substantially the entire support structure 138, comprises a salt or a salt-based fracturable material.

In an embodiment, the entire cross section of the interface 140 can comprise the fracturable material 132. In another embodiment, only a portion of the cross-section of interface 140 is reacted with the reactant or reactant gas to form the fracturable material 132. In another alternate embodiment, at least a portion of the cross-section of interface 140 is printed with a polymer-based or salt-based print material to form the fracturable material 132. This can allow the thermal conductivity and/or electrical conductivity to be maintained while still lowering the strength of the interface to allow for ease of fracturing. Reacting only a portion of the interface to maintain conductivity may be desirable if the goal is to use the article 136 without carrying out post printing heat treatments.

In an embodiment, the article material, support structural material and fracturable material are formed by printing the layers using a print material that is a polymer. In certain embodiments, the aforementioned article material or support structural material can be formed by printing the layers using a print material that is a liquid metal. For example, forming the layers can comprise jetting the print material in an ambient atmosphere onto a print substrate, such as the build plate 122. As will be described in more detail below, the ambient atmosphere can be modified to form a fracturable material or a modified fracturable material. When forming the fracturable material, for instance, the ambient atmosphere can comprise the reactant gas in sufficient amounts such as greater than 10%, such as about 15% to about 100%, or about 20% to about 90% by volume, to convert the printable material to a modified fracturable material. When forming the article 136 or metal portions of support structures 138, the ambient atmosphere does not comprise substantial amounts of the reactant or reactant gas, but instead employs an inert or substantially inert atmosphere, such as an inert gas or vacuum. For example, the amount of oxygen or other reactant gas can range from 0% to less than 10% by volume, such as less than 5% by volume, less than 1% by volume or less than 0.1% by volume, depending on the reactivity of the system being printed.

After the three-dimensional build 126 is printed, the method can further include cooling the article 136 and the support structures 138. If the additive manufacturing process employs liquid metal jetting, the entire process can be carried out without sintering the article 136. In other 3D printing processes, sintering can be carried out on the three-dimensional build, either before or after removal of the support structures 138.

The method can further comprise removing the support structures 138 by fracturing the fracturable material at, for example, the interface 140. The fracturing and removal of the support structures can occur without employing a mechanical cutting device, such as a saw, wire cutters or other such device. For example, the fracturing can be carried out using a technique chosen from vibrating the structural support, such as by employing an ultrasonic bath, or by contacting the structural support with a pressurized fluid, such as a water jet. The fracturable interface combined with such removal processes can allow for one or more of the following advantages: easy removal of the structural support, the removal of supports from internal structures that would be difficult or impossible to get to with a cutting tool, and/or improved surface quality of the final 3D article. In certain embodiments, for example with the use of a soluble print material, pressure is not necessary for removal of the fracturable material. Illustrative examples include print materials, salts, or polymers soluble in water, such as liquid soluble polymers or monomers or liquid soluble salts.

The methods of the present disclosure can be employed with any type of additive manufacturing process, such as extrusion techniques, jetting techniques, and so forth. In an embodiment, the process is carried out with liquid metal deposition printing, such as a metal jetting process. One known technique for jetting metals employs a magnetohydrodynamic (MHD) printer, which is suitable for jetting liquid metal layer upon layer to form a 3D metallic object. Another known technique for jetting employs a salt-based liquid printing process. Still another known technique for jetting employs polymer-based printing materials, such as, for example, a liquid polymer printing material or a filament-based polymer printing material.

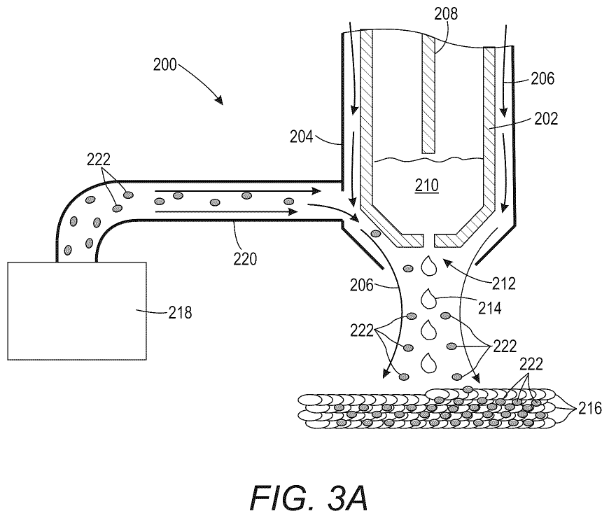

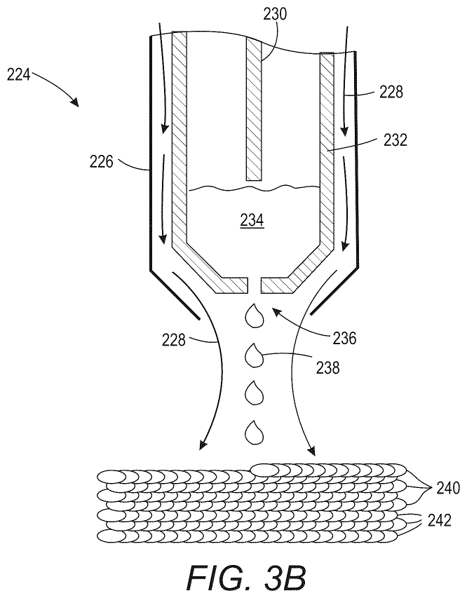

FIG. 3A is a schematic cross-sectional view of a single liquid ejector jet configured for jetting modified metal compositions, such as fracturable materials, in a metal jetting process, according to an embodiment of the present disclosure. A liquid ejector jet 200 is shown in FIG. 3, the liquid ejector jet 200 defining a nozzle 202 portion having a gas shield 204 surrounding the nozzle 202 portion. The gas shield 204 surrounds the nozzle 202 and contains a first gas 206, also referred to as a cover gas. The cover gas surrounds the nozzle 202 with the cover gas 206. This gas or air shield 204 provides an air shield around an external portion of the nozzle 202. The gas shield 204 surrounds the printing operation with an inert cover gas 206, which may be used to regulate temperature and atmosphere around the liquid ejector jet 200.

The 3D printer and accompanying liquid ejector jet 200 may also include one or more gas-controlling devices, which may be or include a source (not shown) of the cover gas 206. The gas source may be configured to introduce the cover gas 206. The cover gas 206 may be or include an inert gas, such as helium, neon, argon, krypton, and/or xenon. In another embodiment, the gas may be or include nitrogen. The gas may include less than about 10% by volume oxygen, less than about 5% oxygen, or less than about 1% by volume oxygen. In at least one embodiment, the gas can be introduced via a gas line which includes a gas regulator configured to regulate the flow or flow rate of one or more gases introduced into and/or around the liquid ejector jet 200 from the gas source. For example, the gas may be introduced at a location that is above the liquid ejector jet 200 and/or above a heating element for heating the gas (not shown). This may allow the gas (e.g., argon) to form a shroud/sheath that functions as an air shield around the liquid ejector jet 200, the drops 214, the 3D object, and/or the substrate to reduce/prevent the formation of oxide (e.g., metal oxide, such as aluminum oxide). In an embodiment, controlling the temperature of the gas can help to control (e.g., minimize) the rate that the oxide formation occurs. Reducing formation of oxide or other non-metals is generally desirable when forming an article and/or support structure that comprises metals that are easily oxidized at printing temperatures.

The liquid ejector jet 200 may define an inner volume, also referred to as an internal cavity, which retains a molten or liquid printing material 210 in the inner volume of the liquid ejector jet 200. The printing material 210 may be or include a metal, a polymer, a molten salt, or the like. For example, the printing material 210 may be or include aluminum or aluminum alloy, introduced via a printing material supply or spool of a printing material wire feed 208 (e.g., aluminum or other metal wire). In another example, the printing material 210 may be or include a polymer introduced via a printing material supply or spool of printing material filament feed 208. In still another example, the printing material 210 may be or include a salt introduced as a molten salt. Certain embodiments may not utilize a wire feed introduction of printing material, but may alternatively include a powder feed, liquid feed, or other method or manner of introducing a printing material into the liquid ejector jet 200.

The nozzle 202 of the liquid ejector jet 200 also defines a nozzle orifice 212. The printing material 210 retained within the nozzle 202 is jetted through the nozzle orifice 212 in the form of one or more liquid drops 214. These liquid printing material drops 214 may be jetted onto a substrate, such as a build plate, a previously jetted layer of drops or both, and can form one or more layers of solidified droplets 216 to eventually form a 3D object.

Referring to FIG. 3A, an additive source 218 is in fluid communication with the nozzle 202, according to an embodiment of the present disclosure. For example, this additive source 218 is coupled to the nozzle 202 of the liquid ejector jet 200 by an additive inlet 220. The additive inlet 220 delivers a reactant 222 from the additive source 218 to the gas shield 204 where the reactant 222 combines with the first gas 206 and is then carried towards the nozzle 202 and nozzle orifice 212 to combine the reactant 222 with the printing material modified droplets 214 of the liquid printing material 210 in proximity to an external portion of the nozzle 202. This process results in the reactant 222 and printing material droplets 214 interacting via a chemical or physical mixing or reaction to create an in situ modified printing material. This in situ modified printing material has a different composition than the original liquid printing material 210.

In embodiments, the reactant 222 is mixed with the cover gas 206 and carried to an area in proximity around the nozzle orifice 212 of the nozzle 202. In an embodiment, only a portion of the 3D printed part has droplets or already formed layers of the printing material having an in situ modification of the molten or liquid printing material to form a fracturable material. For example, a portion of the print material, such as at the interface 140 or an entire structural support 138, can be formed as a fracturable material. For example, it should be noted that when certain printing materials, such as a salt-based printing material, an additional interface structure or fracturable interface portion need not be printed, and the fracturable interface would be an integral portion of the support structure.

In an embodiment, the fracturable material can be formed by exposing one or more of the printing materials either prior to, or after, deposition onto the substrate, or both. For example, exposure of a first printing material or a second printing material to the reactant can occur during deposition of the droplets or after deposition of the layers of metal, or both. The addition of a vapor-based or gaseous reactant 222 to modify a printing material droplet or formed printed layer, such as, but not limited to layers comprising polymer or salt, would result in the formation of a structurally modified polymer or salt as a fracturable material. The addition of solvents, water vapor, low molecular weight monomers or polymers, polymer or monomer vapor, plasticizing vapor materials, sources for vapor deposited polymers, and the like, would result in the formation of potentially fracturable materials comprising polymers or salts.

FIG. 3B is a schematic cross-sectional view of a single liquid ejector jet configured for jetting various material compositions, according to an embodiment of the present disclosure. A liquid ejector jet 224 is shown in FIG. 3B, the liquid ejector jet 224 defining a nozzle 232 portion having a gas shield 226 surrounding the nozzle 232 portion. The gas shield 226 surrounds the nozzle 232 and contains a first gas 228, also referred to as a cover gas. The cover gas surrounds the nozzle 232 with the cover gas 228. This gas or air shield 226 provides an air shield around an external portion of the nozzle 232. The gas shield 226 surrounds the printing operation with an inert cover gas 228, which may be used to regulate temperature and atmosphere around the liquid ejector jet 224.

The 3D printer and accompanying liquid ejector jet 224 may also include one or more gas-controlling devices, which may be or include a source (not shown) of the cover gas 228. The gas source may be configured to introduce the cover gas 228. The cover gas 228 may be or include an inert gas, such as helium, neon, argon, krypton, and/or xenon. In another embodiment, the gas may be or include nitrogen. The gas may include less than about 10% by volume oxygen, less than about 5% oxygen, or less than about 1% by volume oxygen. In at least one embodiment, the gas can be introduced via a gas line which includes a gas regulator configured to regulate the flow or flow rate of one or more gases introduced into and/or around the liquid ejector jet 224 from the gas source. For example, the gas may be introduced at a location that is above the liquid ejector jet 224 and/or above a heating element for heating the gas (not shown). This may allow the gas (e.g., argon) to form a shroud/sheath that functions as an air shield around the liquid ejector jet 224, the drops 238, the 3D object, and/or the substrate to reduce/prevent the formation of oxide (e.g., metal oxide, such as aluminum oxide). In an embodiment, controlling the temperature of the gas can help to control (e.g., minimize) the rate that the oxide formation occurs. Reducing formation of oxide or other non-metals is generally desirable when forming an article and/or support structure that comprises metals that are easily oxidized at printing temperatures.

The liquid ejector jet 224 may define an inner volume, also referred to as an internal cavity, which retains a molten or liquid printing material 234 in the inner volume of the liquid ejector jet 224. The printing material 234 may be or include a metal, a polymer, a molten salt, or the like. For example, the printing material 234 may be or include aluminum or aluminum alloy, introduced via a printing material supply or spool of a printing material wire feed 230 (e.g., aluminum or other metal wire). In another example, the printing material 234 may be or include a polymer introduced via a printing material supply or spool of printing material filament feed 230. In still another example, the printing material 234 may be or include a salt introduced as a molten salt. Certain embodiments may not utilize a wire feed introduction of printing material, but may alternatively include a powder feed, liquid feed, or other method or manner of introducing a printing material into the liquid ejector jet 224.

The nozzle 232 of the liquid ejector jet 224 also defines a nozzle orifice 236. The printing material 234 retained within the nozzle 232 is jetted through the nozzle orifice 236 in the form of one or more liquid drops 238. These liquid printing material drops 238 may be jetted onto a substrate, such as a build plate, a previously jetted layer of drops or both, and can form one or more layers of solidified droplets 240 to eventually form a 3D object. As shown in FIG. 3B, the printing material 234 can be a first printing material or a second printing material, such that the solidified droplets 240 forming the 3D object may be deposited upon a previously deposited layer of solidified droplets of a first or different printing material 242.

Referring to FIG. 3B, once an article is printed using a first printing material 242, the article may be moved or otherwise positioned under the liquid ejector jet 224 to deposit the printing material 234 retained within the nozzle 232, which can comprise a fracturable interface, a support structure material onto an article. It should be noted that the printing of an article, a support structure, or a fracturable interface may be conducted in any order. In certain examples, the article can comprise a metal, salt, polymer, or combination thereof. In other examples, the support structure can comprise a metal, salt, polymer, or combination thereof. In still other examples, the fracturable material or fracturable interface can comprise a metal, salt, polymer, or combination thereof. It should be noted that when certain printing materials, such as a salt-based printing material, an additional interface structure or fracturable interface portion need not be printed, and the fracturable interface would be an integral portion of the support structure.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein.

While the present teachings have been illustrated with respect to one or more implementations, alterations and/or modifications can be made to the illustrated examples without departing from the spirit and scope of the appended claims. In addition, while a particular feature of the present teachings may have been disclosed with respect to only one of several implementations, such feature may be combined with one or more other features of the other implementations as may be desired and advantageous for any given or particular function. Furthermore, to the extent that the terms “including,” “includes,” “having,” “has,” “with,” or variants thereof are used in either the detailed description and the claims, such terms are intended to be inclusive in a manner similar to the term “comprising.” Further, in the discussion and claims herein, the term “about” indicates that the value listed may be somewhat altered, as long as the alteration does not result in nonconformance of the process or structure to the illustrated embodiment. Finally, “exemplary” indicates the description is used as an example, rather than implying that it is an ideal.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method of additive manufacturing, the method comprising:
i) forming a first layer, the first layer comprising at least one material chosen from an article material, a support structure material and a fracturable material;
ii) forming an additional layer on the first layer, the additional layer comprising at least one material chosen from the article material, the support structure material and the fracturable material; and
iii) repeating ii) one or more times to form a three-dimensional build comprising an article and at least one support structure attached to the article at an interface, the interface comprising the fracturable material formed during one or more of i), ii) or iii), the fracturable material comprising a salt.

2. The method of claim 1, wherein the salt comprises sodium carbonate.

3. The method of claim 1, wherein the article material is a metal.

4. The method of claim 1, wherein the support structure material is a metal.

5. The method of claim 1, wherein the article material is a metal and further wherein the entire at least one support structure comprises a polymer.

6. The method of claim 1, wherein the article material is a metal and further wherein the entire at least one support structure comprises a salt.

7. The method of claim 1, wherein the fracturable material is soluble in water.

8. The method of claim 1, wherein the support structure is soluble in water.

9. The method of claim 1, further comprising removing at least one support structure by fracturing the fracturable material at the interface, wherein the fracturing occurs without employing a mechanical cutting device.

10. The method of claim 9, wherein the fracturing is carried out using a technique chosen from vibrating the structural support and contacting the structural support with a pressurized fluid.

11. The method of claim 1, wherein more than one support structures are formed, and the more than one support structures are spaced from about 2 mm to about 20 mm apart.

12. The method of claim 11, wherein a ratio of a total length of an overhang of all of the support structures to a total width of all of the support structures is from about 10:1 to about 2:1.

13. A method of additive manufacturing, the method comprising:
i) jetting droplets comprising a first print material to form a first layer, the first layer comprising at least one material chosen from an article material, a support structure material and a fracturable material;
ii) jetting additional droplets comprising the first print material to form an additional layer on the first layer, the additional layer comprising at least one material chosen from the article material, the support structure material and the fracturable material; and
iii) repeating ii) one or more times to form a three-dimensional build comprising an article and at least one support structure attached to the article at an interface, the interface comprising the fracturable material formed during one or more of i), ii) or iii), the fracturable material being formed by exposing portions of the first print material in at least one form chosen from the droplets, the additional droplets, the first layer and the addition layer with a reactant.

14. The method of claim 13, wherein the reactant comprises a liquid and the fracturable material comprises a liquid soluble salt.

15. The method of claim 14, wherein the liquid soluble salt comprises sodium carbonate.

16. The method of claim 13, wherein the reactant comprises a gas.

17. A three-dimensional build, comprising:
an article comprising a first print material; and
at least one support structure attached to the article at a fracturable interface, the fracturable interface comprising a second print material that is different from the first print material.

18. The three-dimensional build of claim 17, wherein the fracturable interface is disposed at a terminus of the support structure.

19. The three-dimensional build of claim 17, wherein the first print material comprises a salt.

20. The three-dimensional build of claim 17, wherein the first print material comprises a metal.

21. The three-dimensional build of claim 17, wherein the second print material comprises a salt.

22. The three-dimensional build of claim 17, wherein the support structure comprises the second print material.

23. The three-dimensional build of claim 22, wherein the first print material comprises a salt.

24. The three-dimensional build of claim 17, wherein the entire support structure comprises the second print material.

25. The three-dimensional build of claim 17, wherein more than one support structures are formed, and the more than one support structures are spaced from about 2 mm to about 20 mm apart.

26. The three-dimensional build of claim 25, wherein a ratio of a total length of an overhang of all of the support structures to a total width of all of the support structures is from about 10:1 to about 2:1.
